(19) United States
(12) Patent Application Publication
(10) Pub. No.: US 2026/0195848 A1
(43) Pub. Date: Jul. 9, 2026

(54) VARIABLE-RATE DIRECTIONAL SCALING SYSTEMS AND METHODS

(71) Applicant: Apple Inc., Cupertino, CA (US)

(72) Inventors: Yun Gong, Cupertino, CA (US); Jim C Chou, San Jose, CA (US)

(21) Appl. No.: 19/012,444

(22) Filed: Jan. 7, 2025

(51) Int. Cl. G06T 3/40; G06V 10/762

(52) U.S. Cl. CPC G06T 3/40; G06V 10/762; G06V 2201/07

(57) ABSTRACT

A device may include an electronic display to display an image based on scaled image data and image processing circuitry to scale input image data to generate the scaled image data based on a relative position of a pixel location of interest corresponding to a scaled pixel value of the scaled image data relative to input pixel locations of the input image data and an angle corresponding to estimated image content at the pixel location of interest. The image processing circuitry may also interpolate intermediate horizontal values at intermediate horizontal locations and intermediate vertical values at intermediate vertical positions between the input pixel locations based on the pixel location of interest, the angle, and the respective input pixel values. The image processing circuitry may determine the scaled pixel value based on the intermediate vertical values and the intermediate horizontal values.

### BACKGROUND

The present disclosure relates generally to image processing and, more particularly, to the scaling of image data used to display images on an electronic display.

Electronic devices often use one or more electronic displays to present visual representations of information as text, still images, and/or video by displaying one or more images (e.g., image frames). For example, such electronic devices may include computers, mobile phones, portable media devices, tablets, televisions, virtual-reality headsets, and vehicle dashboards, among many others. To display an image, an electronic display may control light emission (e.g., luminance) of its display pixels based at least in part on corresponding image/pixel data.

Image data may start at a particular resolution (e.g., density of pixels to be used to display the image). However, in some instances, it may be desirable to scale the image to a higher resolution, for example for viewing on an electronic display with a higher resolution output. Thus, before being used to display an image, the image data may be processed to convert the image data to a desired resolution. However, in some scenarios scaling may introduce image artifacts such as blurriness, jagged edges (e.g., staircasing), and/or loss of detail.

### SUMMARY

In some instances, an electronic device may scale image data to change the resolution thereof based at least in part on the content of an image corresponding to the image data. For example, directional scaling may be performed in the horizontal and/or vertical directions based on determined angles in the content of the image data to reduce the likelihood of image artifacts such as blurriness, jagged edges (e.g., staircasing), and/or loss of detail. However, while fixed ratio directional scaling may entail multiple iterations of scaling and/or the use of non-directional scaling methods (which may introduce image artifacts) to obtain scaling ratios different from the fixed ratios, aspects of the present disclosure may reduce the number of iterative scaling operations and/or reduce or eliminate non-content-based scaling operations, by performing directional scaling at a variable scaling ratio. For example, instead of directionally scaling at a fixed ratio (e.g., 2×, 4×), the scaling ratio may be selected as any ratio between 1× and 4× (e.g., to a defined decimal level (e.g., 2.1×, 2.12×, 2.123×).

In performing variable directional scaling, a scaler block of image processing circuitry may determine the pixel locations of interest corresponding to new pixel locations of scaled image data based on a selected scaling ratio. As should be appreciated, the scaling ratio may be selected automatically, such as to fill a portion of the electronic display and/or may be user selectable, such as by a user input selecting an amount of scaling (e.g., zoom). Furthermore, in some embodiments, the scaling ratios for the horizontal and vertical directions may be the same or different. Based on the input image data, best mode data, including a best angle estimated to be indicative of the image content at the input pixel locations, may be determined.

Additionally, for each pixel location of interest, the scaler block may determine intermediate vertical values (e.g., vertically interpolated from input pixel values) and intermediate horizontal values (e.g., horizontally interpolated from input pixel values) that lie on lines corresponding to the best angle and an orthogonal angle (e.g., orthogonal to the best angle) and passing through the pixel location of interest (e.g., to be interpolated). Additionally, the relative placement of the pixel location of interest (e.g., the relative distances between nearby input pixel locations and the pixel location of interest) may be used to define interpolation weights, and the interpolation weights may weight an interpolation between the intermediate horizontal and vertical values to generate the new pixel value for the pixel location of interest. As such, the scaling ratio may change the relative locations of the pixels of interest, intermediate horizontal values, intermediate vertical values, and the weights for interpolating the new pixel values on a per pixel basis. As such, the scaler block may perform directional scaling at a variable scaling ratio to reduce subsequent scaling operations (e.g., improving efficiency) and/or reduce the likelihood of image artifacts (e.g., improving image quality).

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a block diagram of the image processing circuitry of FIG. 1 including a color scaler block, in accordance with an embodiment;

FIG. 8 is a block diagram of the scaler block of FIG. 7 including an angle detection block and a directional scaling block, in accordance with an embodiment;

FIG. 9 is a schematic view of pixel locations and example samplings thereof, in accordance with an embodiment;

FIG. 10 is a schematic view of pixel locations and example samplings thereof, in accordance with an embodiment;

FIG. 11 is a flowchart of an example process of angle detection via the angle detection block of FIG. 8, in accordance with an embodiment;

FIG. 12 is a block diagram of the directional scaler block of FIG. 8, in accordance with an embodiment;

FIG. 13 is a schematic diagram of a pixel location of interest, horizontal intermediate locations, and vertical intermediate locations associated with a best angle less than 45 degrees (with respect to the horizontal), disposed within a pixel grid of input pixel locations, in accordance with an embodiment;

FIG. 14 is a schematic diagram of a pixel location of interest, horizontal intermediate locations, and vertical intermediate locations associated with a best angle greater than 45 degrees (with respect to the horizontal), disposed within a pixel grid of input pixel locations, in accordance with an embodiment;

FIG. 15 is a schematic diagram of a pixel location of interest, horizontal intermediate locations, and vertical intermediate locations associated with a best angle less than 45 degrees (with respect to the horizontal), disposed within a pixel grid of input pixel locations, in accordance with an embodiment;

FIG. 16 is a schematic diagram of a pixel location of interest, horizontal intermediate locations, and vertical intermediate locations associated with a best angle greater than 45 degrees (with respect to the horizontal), disposed within a pixel grid of input pixel locations, in accordance with an embodiment;

FIG. 17 is a schematic diagram of a pixel location of interest, horizontal intermediate locations, and vertical intermediate locations associated with a best angle of 45 degrees (with respect to the horizontal), disposed within a pixel grid of input pixel locations, in accordance with an embodiment;

FIG. 18 is a schematic diagram of a pixel location of interest and exterior point locations defining regions within a pixel grid of input pixel locations, in accordance with an embodiment;

FIG. 19 is a schematic diagram of a relative position of the pixel location of interest of FIG. 18 within a region defined by four exterior point locations, in accordance with an embodiment; and

FIG. 20 is a flowchart of an example process for performing directional scaling via the directional scaling block of FIG. 12, in accordance with an embodiment.

### DETAILED DESCRIPTION OF SPECIFIC EMBODIMENTS

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

To facilitate communicating information, electronic devices often use one or more electronic displays to present visual representations of information via one or more images (e.g., image frames). Such electronic devices may include computers, mobile phones, portable media devices, tablets, televisions, virtual-reality headsets, and vehicle dashboards, among many others. Additionally or alternatively, an electronic display may take the form of a liquid crystal display (LCD), a light emitting diode (LED) display, an organic light emitting diode (OLED) display, a plasma display, or the like.

In any case, to display an image, an electronic display generally controls light emission (e.g., luminance and/or color) of its display pixels based on corresponding image data received at a particular resolution (e.g., pixel dimensions). For example, an image data source (e.g., memory, an input/output (I/O) port, and/or a communication network) may output image data as a stream of pixel data (e.g., image data), in which data for each pixel indicates a target luminance (e.g., brightness and/or color) of one or more display pixels located at corresponding pixel positions. In some embodiments, image data may indicate luminance per color component, for example, via red component image data, blue component image data, and green component image data, collectively RGB. Additionally or alternatively, image data may be indicated by a luma channel and one or more chrominance channels (e.g., YCbCr, YUV), grayscale (e.g., gray level), or other color basis. It should be appreciated that a luma channel, as disclosed herein, may encompass linear, non-linear, and/or gamma corrected luma values.

To facilitate improving perceived image quality, image data may be processed before being output to an electronic display or stored in memory for later use. For example, a processing pipeline, implemented via hardware (e.g., circuitry) and/or software (e.g., execution of instructions stored in tangible, non-transitory media), may facilitate such image processing. In some instances, it may be desirable to scale image data to a higher resolution, for example to match the resolution of an electronic display or to make the image, or a portion thereof, appear larger. However, at least in some instances, this may affect perceived image quality, for example, by resulting in perceivable visual artifacts, such as blurriness, jagged edges (e.g., staircasing), and/or loss of detail.

Accordingly, to facilitate scaling with reduced visual artifacts (e.g., increased image quality), the present disclosure provides techniques for directionally scaling an image based on the image content increase the pixel resolution (e.g., pixel density corresponding to a portion of image content). For example, in some embodiments, image processing circuitry may include a scaler block to directionally scale image data while accounting for lines, edges, patterns, and/or angles within the image. Such content dependent processing may allow for the image data to be scaled to a higher resolution without, or with a reduced amount of, artifacts. In some embodiments, the ability to increase the resolution of an image without introducing noticeable artifacts may allow for images to be stored at a lower resolution, thus saving memory space and/or bandwidth, and restore the image to a higher resolution before displaying the image.

In some embodiments, the scaler block may include, for example, an angle detection block to determine best mode data indicative of content-based statistics of the image data and a directional scaling block to interpolate new pixel values based on the input image data and the best mode data. The angle detection block may gather statistics, such as based on the sum of absolute differences (SAD) and/or differentiation (DIFF), to determine one or more angles of the best mode data indicative of the content at the different pixel locations. For example, the SAD and/or DIFF statistics may be calculated based on sets of pixel values of the input image data corresponding to multiple different angles to identify which angle(s) are most likely to be indicative of the image content at the pixel locations. The best mode data may contain, for example, best angles, weights, and/or confidences for each pixel location (e.g., input pixel locations used as references to interpolate new pixel values) to aid in the directional scaling of the image data. The directional scaling block may take the input image data and the best mode data and interpolate the new pixel values, thus generating scaled image data.

In some scenarios, directional scaling may be performed at a fixed scaling ratio (e.g., 2×, 4×) in the horizontal and/or vertical directions. For example, weights for interpolations of the new pixel values may be preset based on the determined angles and/or confidences thereof. However, fixed ratio directional scaling may entail multiple iterations of scaling and/or the use of non-directional scaling methods to obtain scaling ratios different from (e.g., greater than or less than) the fixed ratios. For example, the scaler block may include a vertical/horizontal scaling block that performs non-content-based scaling, such as via linear scaling, bilinear scaling, and/or polyphase scaling. To reduce the number of iterative scaling operations and/or reduce or eliminate non-content-based scaling operations, the techniques discussed herein provide for a variable directional scaling ratio, such as any ratio between 1× and 2×, any ratio between 1× and 4×, any ratio between 1× and 8×, any ratio between 1× and 16×, and so on. As should be appreciated, the granularity of the selectable scaling ratio may depend on implementation (e.g., a defined decimal level (e.g., 2.1×, 2.12×, 2.123×), such as based on the pixel density of the input image data, the pixel density of the electronic display, memory constraints).

In performing variable directional scaling, the scaler block may determine the pixel locations of interest corresponding to the new pixel locations of the scaled image data based on a selected scaling ratio. As should be appreciated, the scaling ratio may be selected automatically, such as to fill a portion of the electronic display and/or may be user selectable, such as by a user input selecting an amount of scaling (e.g., zoom). Furthermore, in some embodiments, the scaling ratios for the horizontal and vertical directions may be the same or different. Based on the input image data, best mode data, including a best angle estimated to be indicative of the image content at the input pixel locations, may be determined.

Additionally, for each pixel location of interest, the scaler block may determine intermediate vertical values (e.g., vertically interpolated from input pixel values) and intermediate horizontal values (e.g., horizontally interpolated from input pixel values) that lie on lines corresponding to the best angle and an orthogonal angle (e.g., orthogonal to the best angle) and passing through the pixel location of interest (e.g., to be interpolated). Additionally, the relative placement of the pixel location of interest (e.g., the relative distances between nearby input pixel locations and the pixel location of interest) may be used to define interpolation weights, and the interpolation weights may weight an interpolation between the intermediate horizontal and vertical values to generate the new pixel value for the pixel location of interest. As should be appreciated, variable rate directional scaling does not necessarily maintain the same relative location for a new pixel within a group of surrounding input pixels. Indeed, the scaling ratio may change the relative distances between a pixel location of interest and the spacing of the input pixel locations. As such, the variable scaling ratio may change the relative locations of the pixels of interest, intermediate horizontal values, intermediate vertical values, and the weights for interpolating the new pixel values on a per pixel basis.

Based on the variable scaling ratio and, therefore, the relative locations of the pixel locations of interest to be interpolated (e.g., relative to the input pixel locations), weights for intermediate pixel values (e.g., horizontal and vertical), determined based on best mode data and the relative locations of the pixel locations of interest, may be determined and used to interpolate the new pixel values of the scaled image data. Moreover, as should be appreciated, the scaler block may be used individually and/or in combination with other image processing blocks to facilitate improved perceived image quality at a higher resolution while reducing the likelihood of image artifacts.

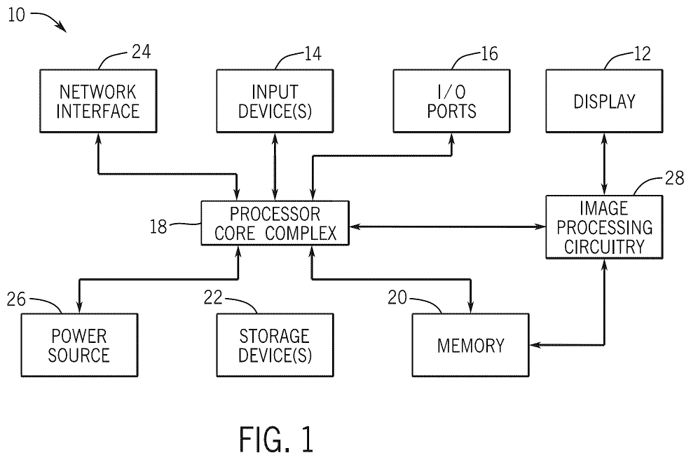

With the foregoing in mind, FIG. 1 is an example electronic device 10 that may incorporate the variable directional scaling techniques discussed herein. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline) may be included, at least in part, in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating, altering, or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. Additionally, the input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). As used herein, a display pixel/pixel may refer to a collection of sub-pixels (e.g., red, green, and blue subpixels) or may refer to a single sub-pixel.

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

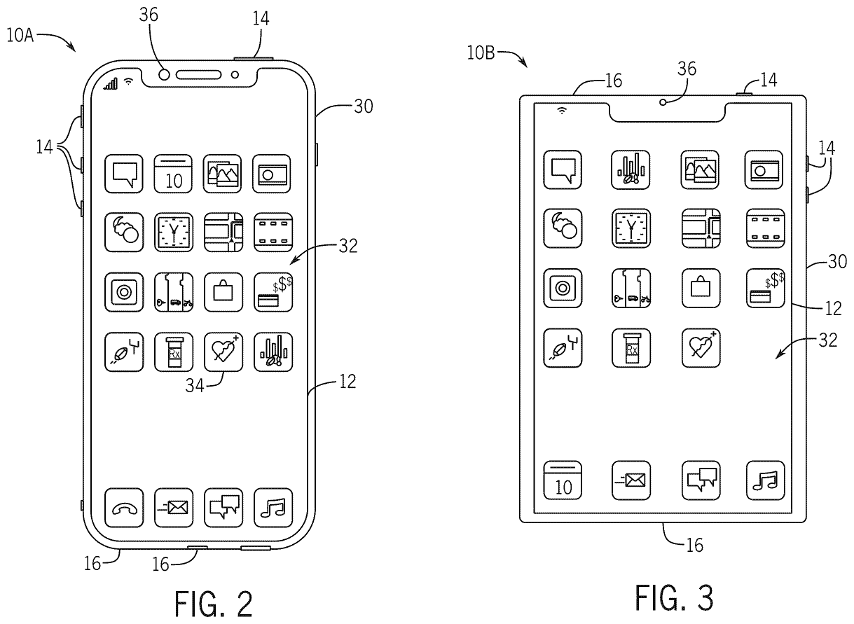

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30 to enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may be accessible through the enclosure 30, such as via one or more openings or cavities. Additionally, the electronic device 10 may include one or more cameras 36 to capture pictures or video. In some embodiments, a camera 36 may be used in conjunction with a virtual reality or augmented reality visualization on the electronic display 12.

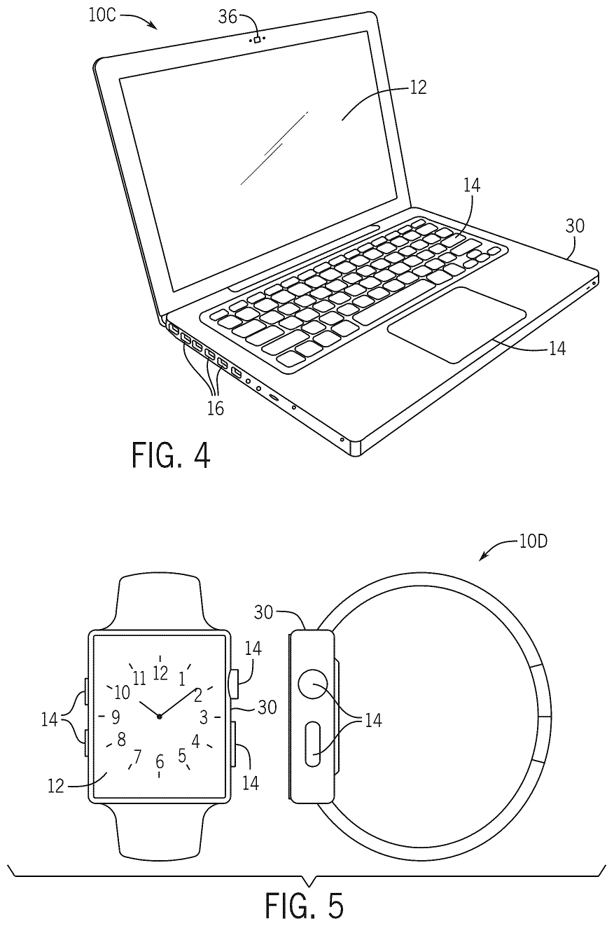

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10 (e.g., wearable electronic device), specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

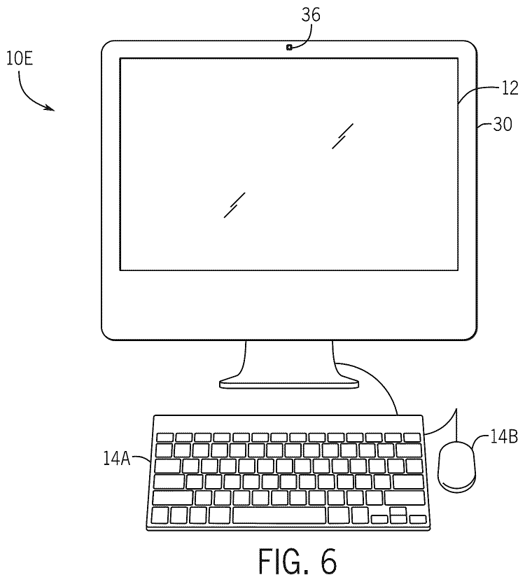

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an IMAC®, a MACBOOK ®, or other similar device by Apple Inc. of Cupertino, California. It should be noted that the computer 10E may also represent a personal computer (PC) by another manufacturer. An enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

As described above, the electronic display 12 may display images based at least in part on image data. Before being used to display a corresponding image on the electronic display 12, the image data may be processed, for example, via the image processing circuitry 28. In general, the image processing circuitry 28 may process the image data for display on one or more electronic displays 12. For example, the image processing circuitry 28 may include a display pipeline, memory-to-memory scaler and rotator (MSR) circuitry, warp compensation circuitry, or additional hardware or software means for processing image data. The image data may be processed by the image processing circuitry 28 to reduce or eliminate image artifacts, compensate for one or more different software or hardware related effects, and/or format the image data for display on one or more electronic displays 12. As should be appreciated, the present techniques may be implemented in standalone circuitry, software, and/or firmware, and may be considered a part of, separate from, and/or parallel with a display pipeline or MSR circuitry.

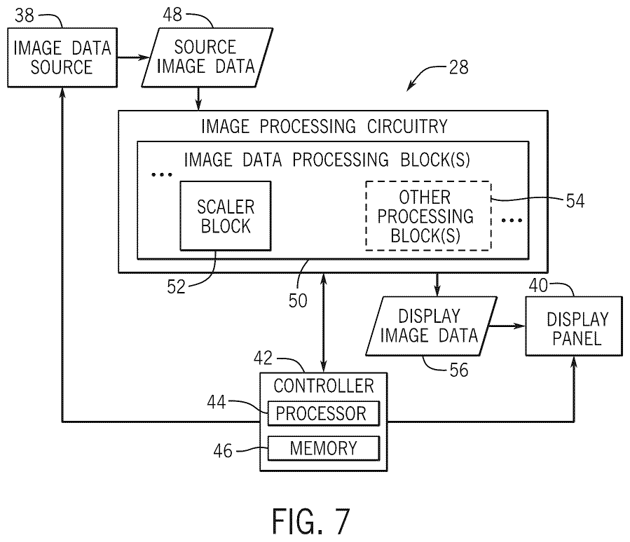

To help illustrate, a portion of the electronic device 10, including image processing circuitry 28, is shown in FIG. 7. The image processing circuitry 28 may be implemented in the electronic device 10, in the electronic display 12, or a combination thereof. For example, the image processing circuitry 28 may be included in the processor core complex 18, a timing controller (TCON) in the electronic display 12, standalone circuitry, or any combination thereof. As should be appreciated, although image processing is discussed herein as being performed via a number of image data processing blocks, embodiments may include general purpose and/or dedicated hardware or software components to carry out the techniques discussed herein.

The electronic device 10 may also include an image data source 38, a display panel 40, and/or a controller 42 in communication with the image processing circuitry 28. In some embodiments, the display panel 40 of the electronic display 12 may be a reflective technology display, a transmissive technology display (e.g., a liquid crystal display (LCD)), a self-emissive technology display (e.g., organic light emitting diode (OLED) display, LED display), or any other suitable type of display panel 40. In some embodiments, the controller 42 may control operation of the image processing circuitry 28, the image data source 38, and/or the display panel 40. To facilitate controlling operation, the controller 42 may include a controller processor 44 and/or controller memory 46. In some embodiments, the controller processor 44 may be included in the processor core complex 18, the image processing circuitry 28, a timing controller in the electronic display 12, a separate processing module, or any combination thereof and execute instructions stored in the controller memory 46. Additionally, in some embodiments, the controller memory 46 may be included in the local memory 20, the main memory storage device 22, a separate tangible, non-transitory, computer-readable medium, or any combination thereof.

The image processing circuitry 28 may receive source image data 48 corresponding to a desired image to be displayed on the electronic display 12 from the image data source 38. The source image data 48 may indicate target characteristics (e.g., pixel data) corresponding to the desired image using any suitable source format, such as an RGB format, an αRGB format, a YCbCr format, and/or the like. Moreover, the source image data may be fixed or floating point and be of any suitable bit-depth. Furthermore, the source image data 48 may reside in a linear color space, a gamma-corrected color space, or any other suitable color space. As used herein, pixels or pixel data therefore may refer to a grouping of sub-pixels (e.g., a grouping of individual color component pixels such as red, green, and blue) or individual sub-pixels.

As described above, the image processing circuitry 28 may operate to process source image data 48 received from the image data source 38. The image data source 38 may include captured images from cameras 36, images stored in memory, graphics generated by the processor core complex 18, or a combination thereof. Additionally, the image processing circuitry 28 may include one or more sets of image data processing blocks 50 (e.g., circuitry, modules, or processing stages) such as a scaler block 52. As should be appreciated, multiple other processing blocks 54 may also be incorporated into the image processing circuitry 28, such as a color management block, a dither block, a pixel contrast control (PCC) block, a burn-in compensation (BIC) block, a rotation block, or other block before and/or after the scaler block 52. The image data processing blocks 50 may receive and process source image data 48 and output display image data 56 in a format (e.g., digital format and/or resolution) interpretable by the display panel 40. As should be appreciated, the processing blocks 50 may include a number of processing blocks in parallel and/or series such that the image data operated by a single block may be the source image data 48 or process image data of another processing block. As such, the functions (e.g., operations) performed by the image processing circuitry 28 may be divided between various image data processing blocks 50, and, while the term “block” is used herein, there may or may not be a logical or physical separation between the image data processing blocks 50.

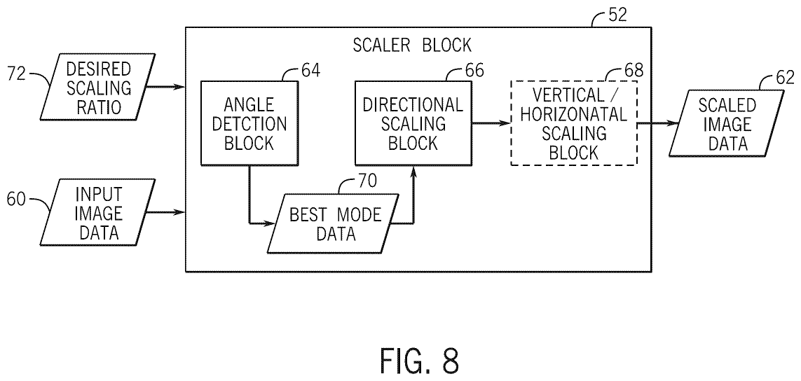

As discussed further herein, in some embodiments, the scaler block 52 may adjust the resolution of an image or a portion thereof via directional scaling to reduce the likelihood for image artifacts generally associated with scaling. As an illustrative example, it may be desirable to increase the resolution of image data to enlarge viewing of an image (or portion thereof) or to accommodate the resolution of an electronic display 12. To help illustrate, FIG. 8 is a block diagram of the scaler block 52, which receives input image data 60, outputs scaled image data 62, and includes an angle detection block 64 and a directional scaling block 66. In some embodiments, the scaler block 52 may also include a vertical/horizontal scaling block 68, such as to operate in conjunction with the directional scaling block 66 and/or as selectively enabled instead of the directional scaling block 66. For example, the vertical/horizontal scaling block 68 may be implemented prior to or after directional scaling for further scaling of the image data (e.g., beyond the scope of the directional scaling block 66) and/or selectively enabled to perform scaling (e.g., generate the scaled image data 62) with directional scaling (e.g., via the directional scaling block 66) disabled. As should be appreciated, any suitable number of iterations of the directional scaling block 66 in series and/or vertical/horizontal scaling block 68 in series in may be implemented for increased scaling capabilities and/or the scaled image data 62 of one iteration of the directional scaling block 66 and/or vertical/horizontal scaling block 68 may be reprocessed by the same directional scaling block 66 and/or vertical/horizontal scaling block 68 (e.g., same circuitry) one or more times for increased scaling capabilities.

As should be appreciated, the scaler block 52 may receive and/or process the input image data 60 in any of multiple color bases (e.g., red-green-blue (RGB), alpha-red-green-blue (ARGB), luma-chrominance (a YCC format, such as YCbCr or YUV)) and/or bit depths (e.g., 8-bit, 16-bit, 24-bit, 30-bit, 32-bit, 64-bit, and/or other appropriate bit depths). For example, in some embodiments, the input image data 60 may include or be transformed (e.g., in the scaler block 52 or other processing blocks 54) to include a channel representing a luma value (e.g., a Y channel), which may retain the content (e.g., edges, angles, lines) of the image. Additionally or alternatively, the processing blocks 50 may use non-luma pixel data to gather and interpret pixel statistics for directional scaling.

The angle detection block 64 of the scaler block 52 may receive input image data 60 and generate best mode data 70 for use by the directional scaling block 66 to interpolate new pixel values of the scaled image data 62. As discussed herein, the best mode data 70 may include angles corresponding to lines and edges of the image content and may include corresponding weights for the angles based on respective confidence levels that the angles are indicative of the image and/or the similarity of the angles to those of neighboring pixels. The generation and analysis of pixel statistics (e.g., SAD and DIFF statistics) along with the assessment of confidences and consistencies may yield the best mode data 70, and the best mode data 70 may facilitate improved directional scaling of the image data. For example, the angle detection block 64 may analyze pixel statistics (e.g., SAD and DIFF statistics) of groups of pixels to identify angles corresponding to lines and/or edges within the content of the input image data 60. Such angles may then be used in the directional scaling block 66 to facilitate improved interpolation of new pixels generated when scaling to a different resolution, according to the desired scaling ratio 72.

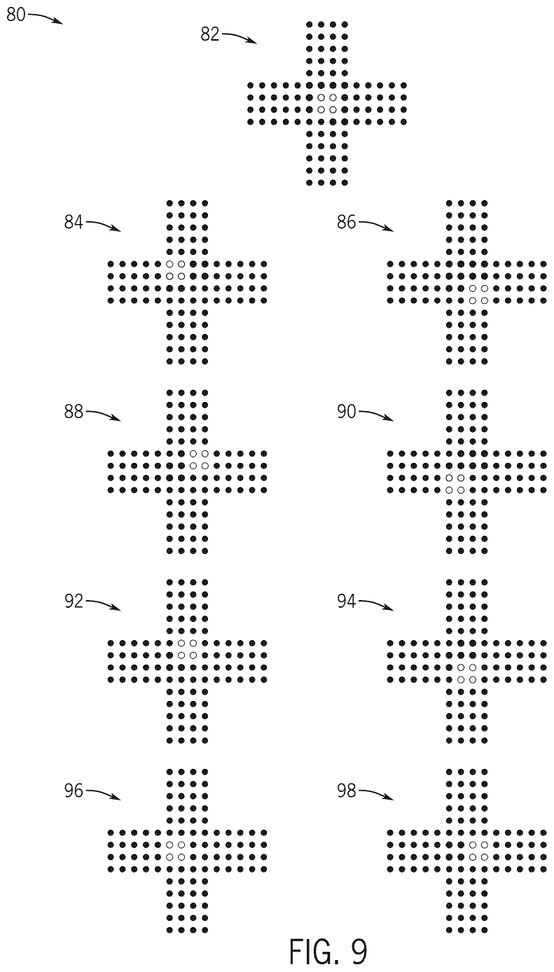

To generate the pixel statistics (e.g., the SAD and DIFF statistics) the angle detection block 64 may analyze the input image data 60 in multiple directions about the input pixel locations. For example, FIG. 9 illustrates multiple pixel groupings 80 for evaluating input image data 60 at different angles. In some embodiments, a rectangular basis pixel cluster 82 is used as a reference from which to determine SAD and DIFF statistics for an input pixel of interest. In some embodiments, the input pixel of interest in the rectangular basis pixel cluster 82 is the top left pixel, however, other pixel locations may be used depending on implementation. When compared to the rectangular basis pixel cluster 82, offset pixel clusters 84, 86, 88, 90, 92, 94, 96, and 98 may yield information about how the pixel data of the input image data 60 changes in the different directions corresponding to the offset pixel clusters 84, 86, 88, 90, 92, 94, 96, and 98. For example, offset pixel clusters 84 and 86 may correspond to a 45 degree offset from the rectangular basis pixel cluster 82. Orthogonal to the 45 degree offset, a 135 degree offset may be represented by offset pixel clusters 88 and 90. Additionally, vertical offset clusters 92 and 94 and horizontal offset clusters 96 and 98 may also be analyzed. In the event a pixel cluster includes a pixel location not within the active region, the pixel value of the closest pixel within the active region may be substituted. In some embodiments, the pixel values of the pixel locations on the edge of the active region may be repeated horizontally and vertically to define values for pixels outside the active region.

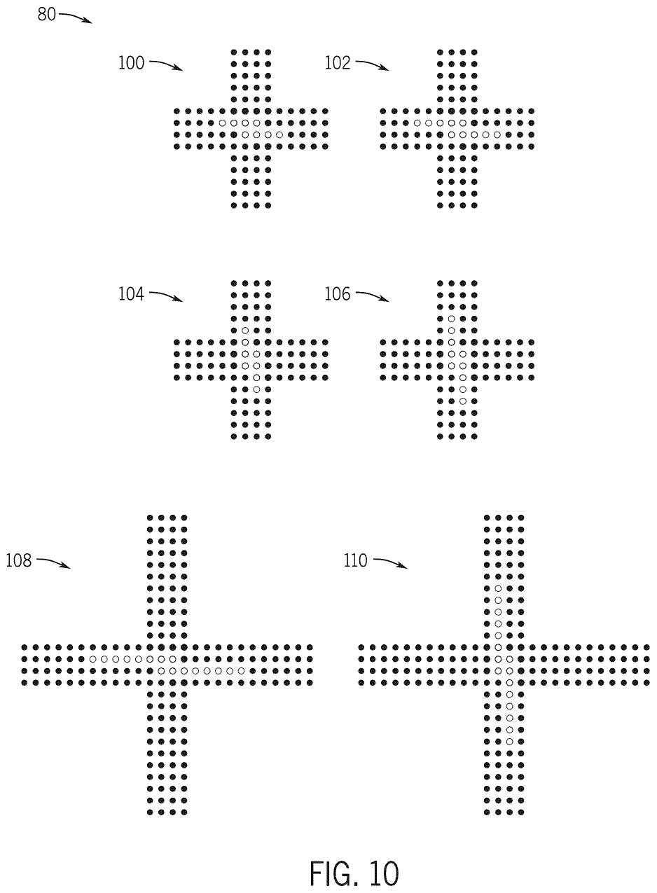

To represent other angles (e.g., angles with slopes other than 0 (horizontal), undefined (vertical), 1 (45 degrees), and −1 (135 degrees)), diagonal basis pixel clusters 100, 102, 104, 106, 108, and 110 may be considered, as shown in FIG. 10. As with the rectangular basis pixel cluster 82, the diagonal basis pixel clusters 100, 102, 104, 106, 108, and 110 may be shifted by an offset and compared to obtain the pixel statistics (e.g., SAD and DIFF statistics) corresponding to the respective angles. In some embodiments, some angles may be better represented by using a greater number of pixels in the pixel cluster. For example, diagonal basis pixel cluster 100 may be used when gathering SAD and DIFF statistics at a slope of ½, and diagonal basis pixel cluster 108 may be used at a slope of ⅙. As such, diagonal basis pixel cluster 100 may utilize more pixels than the rectangular basis pixel cluster 82 and less than diagonal basis pixel cluster 108.

In some embodiments, the angle detection block 64 may utilize the sum of absolute differences (SAD) between the basis and offset pixel groupings 80 to calculate metrics for each potential angle. As should be appreciated, the potential angles and pixel groupings 80 to be analyzed may be set based on implementation, and the provided examples of FIGS. 9 and 10 are non-limiting. In some embodiments, evaluation of the content of an image may be accomplished at multiple types of gradients (e.g., slopes, curves, angles). In addition to using the SAD, differential (DIFF) statistics may also be gathered. For example, DIFF statistics may include metrics such as the difference between successive pixels (e.g., in a line or curve), an edge metric to determine corners and/or edges within the content of the image, and/or other metrics.

To determine the best mode data 70, the angle detection block 64 may normalize the angle statistics to account for the different number of pixels used at different angles and/or modify the best mode data 70 to account for confidence. For example, in some embodiments, the analyses for each angle and/or metric may be adjusted based on the angle checked. In some scenarios, lower angles (e.g., those with a slope less than ⅓ or ¼ or greater than 2 or 3) may be susceptible to false positives when undergoing SAD and DIFF analysis. As such, confidence in low angle analyses may be less than confidence in a horizontal or vertical direction and, thus, low angle analyses may be adjusted accordingly. Based on the SAD and DIFF analyses, the angle detection block 64 may determine the best angles. The best angle for a pixel of the input image data corresponds to that which best approximates the direction of a uniformity (e.g., a line, an edge) in the content of the image.

In some embodiments, the angle detection block 64 may utilize a high frequency and low angle detection to further evaluate the determined best angle(s). In some scenarios, the content of an image may have high frequency features (e.g., a checkerboard pattern) that may result in indications of angles that do not accurately represent the image (e.g., false angles). The high frequency and low angle detection may search, for example using the horizontal and vertical DIFF statistics, for such high frequency features. In some embodiments, the best angle(s) may be used to interpolate intermediate pixel values between those of the original pixels, and the high frequency and low angle detection may check whether the approximated interpolations are consistent with neighboring pixels.

Furthermore, if the best angle and/or second best angle are low angles with reference to the horizontal and vertical (e.g., slopes less than ⅓ and greater than 3) and a high frequency feature or low angle dilemma is detected, the confidence for the low angle(s) may be reduced. In one embodiment, if the best angle is a low angle, the second best angle is not a low angle, and a high frequency feature is detected, the second best angle may replace the best angle in the best mode data 70 as the new best angle.

Additionally, the angle detection block 64 may also check angle consistency. For example, the best angle and second best angle may be considered consistent if the difference between them is less than a threshold. Moreover, the angle detection block 64 may check the best angle of adjacent input pixels for consistency. Angle consistency may boost confidence of the best angle and/or decrease confidence if the angles are not consistent. Additionally, in some embodiments, the confidence metrics of the best angle may also be compared to that of its orthogonal angle to further modify the confidence levels. For example, if the confidence that a line or edge in the content of the image exists in the orthogonal direction is nearly as high as that of the best angle, the confidence level for the best angle may be reduced.

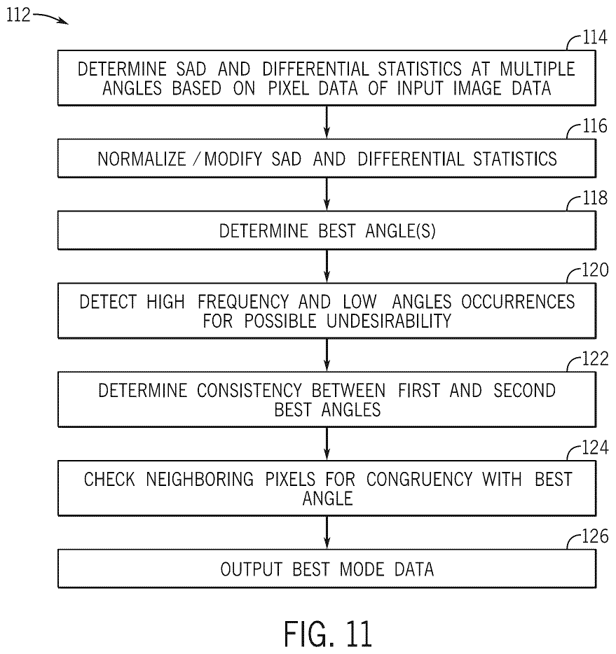

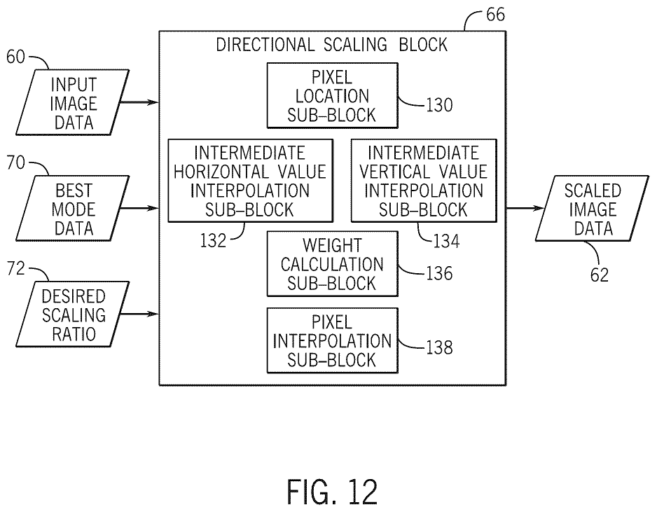

FIG. 11 is a flowchart 112 depicting the operation of the angle detection block 64 for a single pixel location. The angle detection block 64 may determine the sum of absolute differences and differential statistics at multiple angles from the pixel data of the input image data 60 (process block 114). The determined SAD and DIFF statistics may be normalized/modified, for example, based on the individual angles (process block 116). Of the angles analyzed, one or more best angles may be determined (process block 118). Using the best angle(s), the angle detection block 64 may detect high frequency and low angle occurrences for possible undesirability (process block 120) and adjust a confidence of the angle(s) accordingly. Additionally, the angle detection block 64 may determine the consistency of angles (process block 122) such as between the first and second best angles and/or between the best angle(s) and orthogonal angles. Neighboring pixels may also be checked for congruency with the determined best angle (process block 124), for example, to update the angle confidence. The angle detection block 64 may then output the best mode data 70 (process block 126), which may include the best angle and/or corresponding weights/confidence levels.

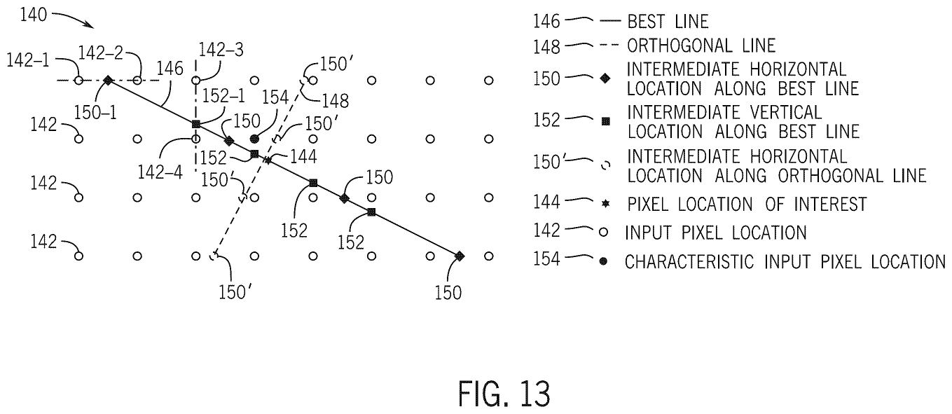

Although discussed above as using the luma pixel data for angle analysis, other color channels may also be used to gather statistics for angle detection. Furthermore, the best mode data 70 gathered from a single channel may be used to scale multiple color channels. When received by the directional scaling block 66, the best mode data 70 may be utilized with the input image data 60 and desired scaling ratio to generate scaled image data 62. To help illustrate, FIG. 13 is a block diagram of the directional scaling block including a pixel location sub-block 130, an intermediate horizontal value interpolation sub-block 132, an intermediate vertical value interpolation sub-block 134, a weight calculation sub-block 136, and a pixel interpolation sub-block 138.

As discussed above, a variable scaling ratio may result in pixel locations of interest to be interpolated that are at various relative locations relative to the input pixel locations. Furthermore, while directional scaling may include interpolations of pixel values along a line at an angle determined to be indicative of the input image data, such pixel values may not be available due to variability of the pixel locations of interest. To help illustrate, FIGS. 13-17 are schematic representations of pixel grids 140 of input pixel locations 142 with a pixel location of interest 144 to be interpolated disposed therein. As discussed herein, the pixel locations of interest 144 to be interpolated may be determined by the pixel location sub-block 130 based on the desired scaling ratio 72. For example, a desired scaling ratio 72 of 2.7× (e.g., 2.7× in the horizontal direction and 2.7× in the vertical direction) may increase the total number of pixels by a multiple of 6.48 with equally spaced pixel locations. However, such non-integer scaling ratios may cause variability in the relative locations of the pixel locations of interest 144 with respect to the pixel grid 140. Indeed, while some scaling ratios may allow reuse of input image data 60 as scaled image data 62 (e.g., for input pixel locations 142 that align with pixel locations of interest 144), in some scenarios, the input pixel locations 142 may not align with any or align with only a portion of the pixel locations of the scaled image data 62.

As a pixel location of interest 144 may not align with the pixel grid 140 of the input pixel locations 142, pixel locations in the vicinity of the pixel location of interest 144 and along a best line 146, corresponding to the best angle of the best mode data 70 and passing through the pixel location of interest 144, may likewise not align with the pixel grid 140. Moreover, in some embodiments, the directional scaling block 66 (e.g., via the pixel interpolation sub-block 138) may interpolate the new pixel value of the pixel location of interest 144 based on values along the best line 146 and/or an orthogonal line 148 (e.g., orthogonal to the best line 146). As such, the intermediate horizontal value interpolation sub-block 132 and intermediate vertical value interpolation sub-block 134 may interpolate intermediate values (e.g., at horizontal intermediate locations 150 and vertical intermediate locations 152, respectively) along the best line 146 and/or along the orthogonal line (e.g., at horizontal intermediate locations 150′ and vertical intermediate locations 152′, respectively) based on the pixel values of the input pixel locations 142.

For example, the intermediate horizontal value interpolation sub-block 132 may interpolate an intermediate value at an example horizontal intermediate location 150-1 based on the pixel values at input pixel locations 142-1 and 142-2, which are horizontally adjacent to the horizontal intermediate location 150-1. As should be appreciated, any suitable interpolation method may be utilized to interpolate between the input pixel locations 142-1 and 142-2 based on the relative location of the horizontal intermediate location 150-1 therebetween. For example, the intermediate value of the horizontal intermediate location 150-1 may be linearly interpolated based on the relative horizontal distances between the horizontal intermediate location 150-1 and the input pixel locations 142-1 and 142-2. Similarly, the intermediate vertical value interpolation sub-block 134 may interpolate an intermediate value at an example vertical intermediate locations 152-1 along the best line 146 based on the pixel values at input pixel locations 142-3 and 142-4, which are vertically adjacent to the vertical intermediate location 152-1 based on the relative vertical distances between the vertical intermediate location 152-1 and the input pixel locations 142-3 and 142-4. As should be appreciated, any suitable interpolation method (e.g., linear interpolation) may be utilized to interpolate between the input pixel locations 142-3 and 142-4 based on the relative location of the vertical intermediate location 152-1 therebetween. As such, the directional scaling block 66 may determine intermediate values at horizontal intermediate locations 150 and vertical intermediate location 152 along the best line 146. As should be appreciated, while four intermediate values at horizontal intermediate locations 150 and four intermediate at vertical intermediate location 152 are shown in FIG. 13, more or fewer intermediate values may be determined depending on implementation.

In addition to the intermediate values along the best line 146, in some embodiments, the directional scaling block 66 (e.g., via the intermediate horizontal value interpolation sub-block 132 and/or intermediate vertical value interpolation sub-block 134) may also determine intermediate values along the orthogonal line 148 (e.g., at horizontal intermediate locations 150′ and/or vertical intermediate locations 152′). Including intermediate values in the orthogonal direction to the best angle in the interpolation of the new pixel value at the pixel location of interest 144 may provide balancing of the new pixel value, such as based on the confidence in the best angle.

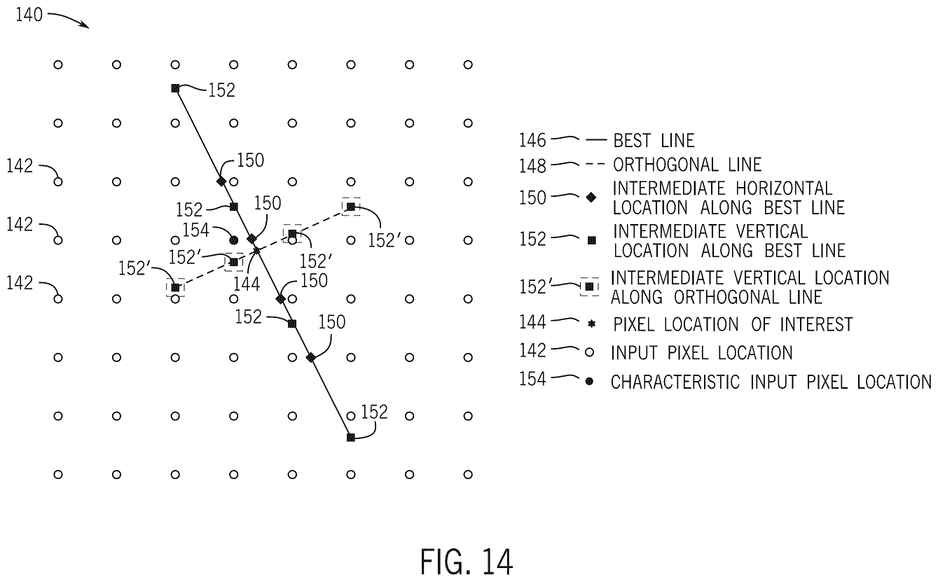

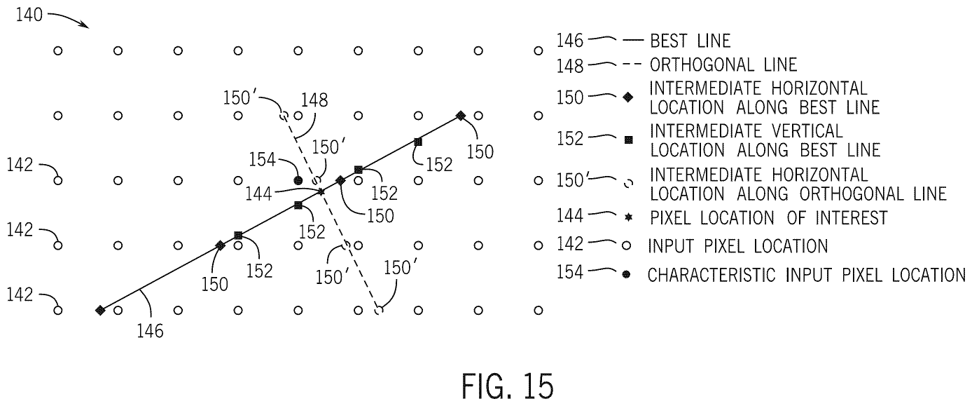

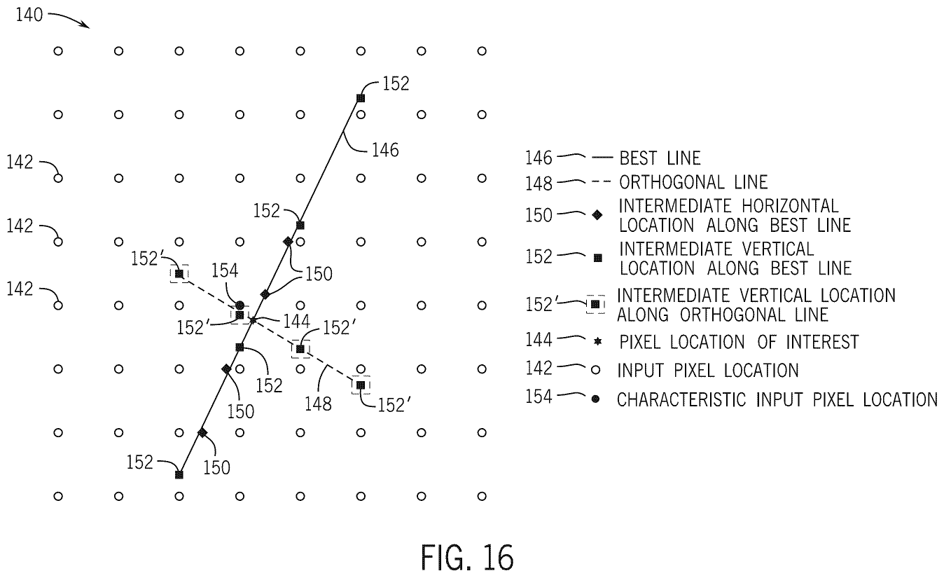

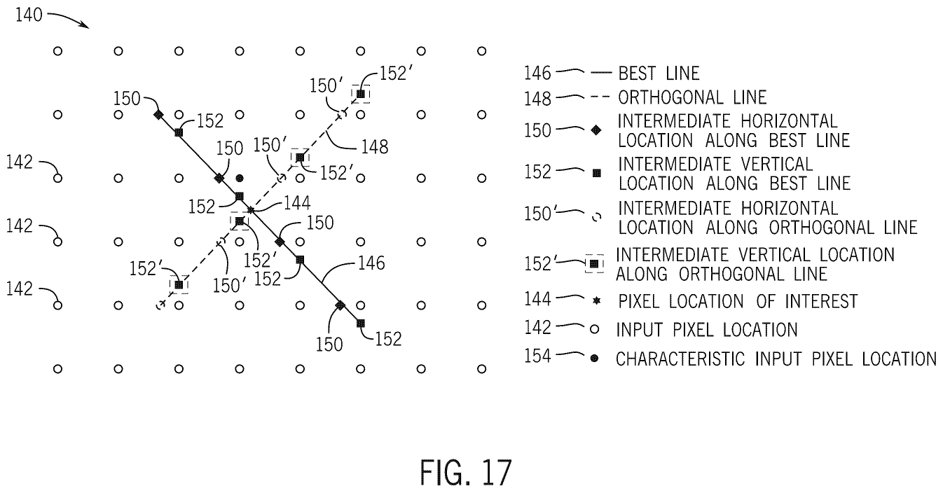

Additionally, in some embodiments, some intermediate values along the orthogonal line 148 may be omitted or otherwise left uncalculated depending on the grade (e.g., intensity/degree) of the best angle. For example, no intermediate values at vertical intermediate locations 152′ are determined for the pixel location of interest 144 in FIG. 13, which has a best angle less than 45 degrees relative to the horizontal, and no intermediate values at horizontal intermediate locations 150′ are determined for the pixel location of interest 144 of FIG. 14, which has a best angle greater than 45 degrees. In cases where the grade of the best angle is relatively shallow (e.g., less than 45 degrees relative to the horizontal), as in FIGS. 13 and 15, the vertical component of the orthogonal line 148 (e.g., how the pixel values change in the vertical direction along the orthogonal line 148) may contribute less (e.g., relative to that of the other intermediate values) to the interpolation of the new pixel value of the pixel location of interest 144. Similarly, in cases where the grade of the best angle is relatively steep (e.g., greater than 45 degrees relative to the horizontal), as in FIGS. 14 and 16, the horizontal component of the orthogonal line 148 (e.g., how the pixel values change in the horizontal direction along the orthogonal line 148) may contribute less to the interpolation of the new pixel value of the pixel location of interest 144. As such, in some scenarios, the calculation of such intermediate values may be forgone, such as to improve computational efficiency. As should be appreciated, such intermediate values may be forgone or not depending on implementation. Moreover, while some intermediate values along the orthogonal line 148 may be forgone for best angles of higher or lower grades, in some embodiments, intermediate values at horizontal intermediate locations 150′ and vertical intermediate locations 152′ along the orthogonal line 148 may both be determined for best angles of 45 degrees, as in FIG. 17. For example, how the pixel values change in the vertical direction along the orthogonal line 148 may have approximately equal contribution to the interpolation of the new pixel value of the pixel location of interest 144 as how the pixel values change in the horizontal direction along the orthogonal line 148. Furthermore, while discussed herein as utilizing the intermediate values along both the best line 146 and the orthogonal line 148, in some embodiments, the directional scaling block 66 may interpolate the new pixel value based on the intermediate values along the best line without determining the orthogonal line 148, horizontal intermediate locations 150′, or vertical intermediate locations 152′.

As discussed above, the locations of the intermediate values may be determined based on the pixel location of interest 144, which is determined based on the desired scaling ratio 72, and the best angle of the best mode data 70. Furthermore, as discussed above, the best mode data 70 is based on the input image data 60 and is, therefore, attributed to input pixel locations 142. In some embodiments, the best mode data 70, and therefore the best angle and best line 146 attributed to (e.g., used for) a pixel location of interest 144 may be based on an adjacent characteristic input pixel location 154. For example, the characteristic input pixel location 154 may be the input pixel location 142 immediately to the upper left of the pixel location of interest 144 of a grouping of the four adjacent surrounding input pixel locations 142. As should be appreciated, which input pixel location 142 is designated as the characteristic input pixel location 154 may depend on implementation. For example, the relative location of the characteristic input pixel location 154 in the grouping of four surrounding input pixel locations 142 may be the same as the relative location of the input pixel of interest in the rectangular basis pixel cluster 82.

As discussed herein, the pixel interpolation sub-block 138 may interpolate the new pixel value of a pixel location of interest 144 from the intermediate values discussed above. As should be appreciated, any suitable method of interpolation may be utilized, such as linear interpolation, bilinear interpolation, or polyphase interpolation, to name a few. In some embodiments, the weight calculation sub-block 136 may determine interpolation weights for the intermediate values, such as for a polyphase interpolation or other interpolation method, based on the best mode data 70 (e.g., weights/confidence levels associated with the best angle(s) and/or orthogonal angle(s)) and the location of the pixel location of interest 144 relative to the characteristic input pixel location 154.

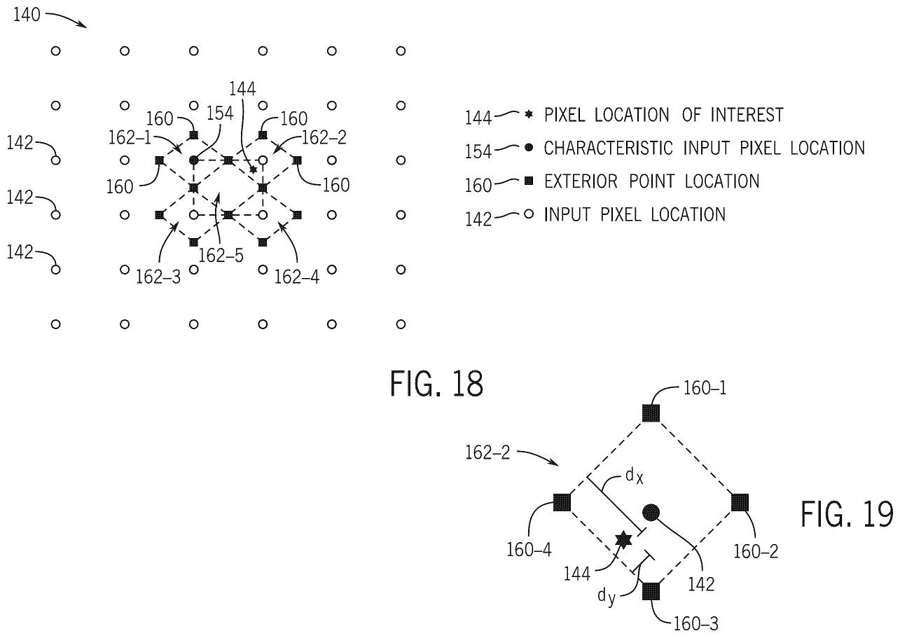

As discussed above, the variable nature of the variable scaling ratio may change the relative position of the pixel location of interest 144 with respect to the pixel grid 140 and the characteristic input pixel location 154. Moreover, as discussed above, the best mode data 70 may include weights (e.g., based on confidence levels and the best angle). Such best mode weights may be indicative of the relative importance of the horizontal direction and vertical direction contributions in defining the best angle at locations within the pixel grid (e.g., exterior point locations). Indeed, higher best mode weights may correspond to a more significant importance of the best angle and, therefore, more emphasis on the horizontal or vertical components thereof in interpolating the new pixel value. As the best mode weights may change (e.g., as defined at the exterior point locations), the interpolation weights of the intermediate values for interpolating the new pixel value of the pixel location of interest 144 may vary based on where the pixel of location is located. To help illustrate, FIG. 18 is a schematic diagram of a pixel grid 140 of input pixel locations 142 with a pixel location of interest 144 disposed therein and a set of exterior point locations 160 that define regions 162 (e.g., 162-1, 162-2, 162-3, 162-4, and 162-5, cumulatively 162) based on the characteristic input pixel location 154. In some embodiments, the region 162 in which the pixel location of interest 144 is located may correspond to which set of exterior point locations 160 are used in determining the interpolation weights. As should be appreciated, the best mode weights at the exterior point locations 160 may be determined via the angle detection block 64. Moreover, the exterior point locations 160 may be positioned at any suitable locations in the pixel grid 140 to define a grid of exterior point locations 160. For example, in some embodiments, the exterior point locations 160 may be positioned at midpoints (e.g., halfway between in the horizontal direction and/or vertical direction) between the input pixel locations 142.

In the example of FIG. 18, the pixel location of interest 144 is located in located in region 162-2, which is depicted in FIG. 19 with exterior point locations 160-1, 160-2, 160-3, and 160-4. Further, the interpolation weight for the pixel location of interest 144 may be determined, such as via the weight calculation sub-block 136, based on the relative location of the pixel of interest 144 within the region 162-2 (e.g., defined by a delta x, dy, and a delta y, dy). For example, the weight calculation sub-block 136 may perform a bilinear interpolation of the best mode weights (or derivatives thereof) associated with the exterior point locations 160 based on the relative location of the pixel of interest 144 within the region 162-2 to determine the interpolation weight for the pixel location of interest 144.

Utilizing the interpolation weight (e.g., a measure of the relative emphasis interpolations using the best angle are to be skewed, according to the best angle) for the pixel location of interest 144, the pixel interpolation sub-block 138 may interpolate the intermediate values of the horizontal intermediate locations 150 and vertical intermediate locations 152 along the best line 146 and/or the horizontal intermediate locations 150′ and vertical intermediate locations 152′ along the orthogonal line 148 to generate the new pixel value for the pixel location of interest 144. As should be appreciated, such may be repeated for other pixel locations of interest 144 to generate the scaled image data 62.

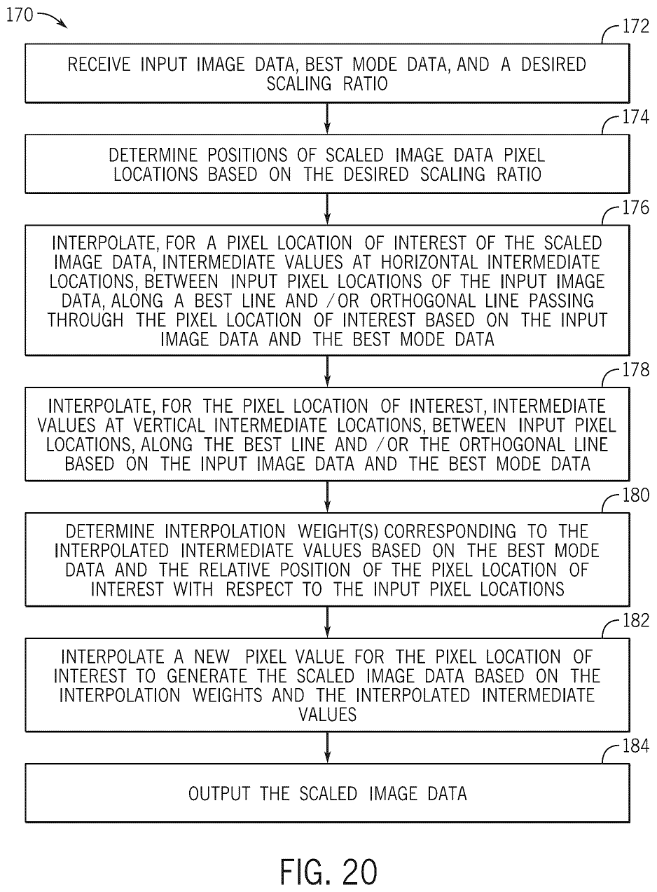

In further illustration, FIG. 20 is a flowchart of an example process 170 for performing variable rate directional scaling via the directional scaling block 66. The directional scaling block 66 may receive the input image data 60, the best mode data 70, and a desired scaling ratio 72 (process block 172). The directional scaling block 66 (e.g., via the pixel location sub-block 130) may also determine the positions of the pixel locations of the scaled image data 62 based on the desired scaling ratio 72 (process block 174). Moreover, the directional scaling block 66 (e.g., via the intermediate horizontal value interpolation sub-block 132) may interpolate, for a pixel location of interest 144 of the scaled image data 62, intermediate values at horizontal intermediate locations 150 and/or 150′, between input pixel locations 142 of the input image data 60, along a best line 146 and/or an orthogonal line 148 passing through the pixel location of interest 144 based on the input image data 60 and the best mode data 70 (process block 176). Similarly, the directional scaling block 66 (e.g., via the intermediate vertical value interpolation sub-block 134) may interpolate, for a pixel location of interest 144, intermediate values at vertical intermediate locations 152 and/or 152′, between the input pixel locations 142, along the best line 146 and/or the orthogonal line 148 based on the input image data 60 and the best mode data 70 (process block 178). Additionally, the directional scaling block 66 (e.g., via the weight calculation sub-block 136) may determine interpolation weight(s) corresponding to the interpolated intermediate values based on the best mode data 70 (e.g., best angle, best mode weights) and the relative location of the pixel location of interest with respect to the input pixel locations 142 (process block 180). Based on the interpolation weights and the interpolated intermediate values, the directional scaling block 66 (e.g., via the pixel interpolation sub-block 138) may determine (e.g., interpolate) a new pixel value for the pixel location of interest 144 (process block 182), thus, generating scaled image data 62. Moreover, the scaled image data 62 may then be output (process block 184), such as for further scaling (e.g., repeated directional scaling and/or via the vertical/horizontal scaling block 68), to one or more other processing blocks 54, and/or to the display panel 40.

As discussed herein, the scaler block 52 may perform directional scaling at a variable scaling ratio to reduce subsequent scaling operations (e.g., improving efficiency) and/or reduce the likelihood of image artifacts (e.g., improving image quality). Although the above flowchart is shown in a given order, in certain embodiments, process/decision blocks may be reordered, altered, deleted, and/or occur simultaneously. Additionally, the flowchart is given as an illustrative tool and further decision and process blocks may also be added depending on implementation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A device comprising:
an electronic display configured to display an image based on scaled image data; and
image processing circuitry configured to scale input image data corresponding to the image from a first resolution to a second resolution to generate the scaled image data, and wherein the image processing circuitry is configured to scale the input image data based on:
obtaining a relative position of a pixel location of interest corresponding to a scaled pixel value of the scaled image data relative to input pixel locations of the input image data, wherein the input image data comprises respective input pixel values at the input pixel locations;
obtaining an angle corresponding to estimated content of the image at the pixel location of interest;
interpolating intermediate horizontal values at intermediate horizontal locations between the input pixel locations based on the pixel location of interest, the angle, and the respective input pixel values;
interpolating intermediate vertical values at intermediate vertical locations between the input pixel locations based on the pixel location of interest, the angle, and the respective input pixel values; and
determining the scaled pixel value based on the intermediate vertical values, and the intermediate horizontal values.

2. The device of claim 1, wherein the image processing circuitry is configured to receive an indicator of a selected value of a variable scaling ratio, wherein the selected value of the variable scaling ratio comprises a ratio between the first resolution and the second resolution.

3. The device of claim 2, wherein the image processing circuitry is configured to determine the relative position of the pixel location of interest based on the indicator of the selected value of the variable scaling ratio.

4. The device of claim 1, wherein the intermediate horizontal locations are on a line corresponding to the angle and passing through the pixel location of interest, and wherein the intermediate vertical locations are on the line.

5. The device of claim 4, wherein the image processing circuitry is configured to scale the input image data based on:
interpolating:
additional intermediate horizontal values at additional intermediate horizontal locations between the input pixel locations based on the pixel location of interest and a second angle orthogonal to the angle;
additional intermediate vertical values at additional intermediate vertical locations between the input pixel locations based on the pixel location of interest and the second angle; or
the additional intermediate horizontal values and the additional intermediate vertical values; and
determining the scaled pixel value based on:
the intermediate vertical values;
the intermediate horizontal values; and
the additional intermediate horizontal values, the additional intermediate vertical values, or both.

6. The device of claim 1, wherein the image processing circuitry is configured to obtain best mode data, comprising the angle, based on:
a first difference between a first pixel cluster and a second pixel cluster, wherein the first pixel cluster comprises an input pixel location of interest of the input pixel locations, wherein the second pixel cluster is offset from the first pixel cluster at a first potential angle; and
a second difference between the first pixel cluster and a third pixel cluster, wherein the third pixel cluster is offset from the first pixel cluster at a second potential angle, wherein the second potential angle is different from the first potential angle.

7. The device of claim 6, wherein the image processing circuitry is configured to select the angle from a plurality of potential angles based on a confidence that the angle is representative of the estimated content of the image, the plurality of potential angles comprising the first potential angle and the second potential angle.

8. The device of claim 7, wherein the best mode data comprises best mode weights indicative of the confidence that the angle is representative of the estimated content of the image, wherein the image processing circuitry is configured to:
determine interpolation weights based on the best mode weights and the relative position of the pixel location of interest relative to the input pixel locations; and
determine the scaled pixel value based on the intermediate vertical values, the intermediate horizontal values, and the interpolation weights.

9. The device of claim 1, wherein the second resolution is greater than the first resolution.

10. A method comprising:
receiving an indicator of a selected value of a variable scaling ratio and input image data corresponding to an image, wherein the selected value of the variable scaling ratio comprises a ratio between a first resolution of the input image data and a second resolution of scaled image data;
determining a relative position of a pixel location of interest corresponding to a scaled pixel value of the scaled image data relative to input pixel locations of the input image data, wherein the input image data comprises respective input pixel values at the input pixel locations;
determining an angle corresponding to estimated content of the image at the pixel location of interest;
interpolating intermediate horizontal values at intermediate horizontal locations between the input pixel locations based on the pixel location of interest, the angle, and the respective input pixel values;
interpolating intermediate vertical values at intermediate vertical locations between the input pixel locations based on the pixel location of interest, the angle, and the respective input pixel values; and
determining the scaled pixel value based on the intermediate vertical values and the intermediate horizontal values.

11. The method of claim 10, comprising selecting the angle from a plurality of potential angles based on a confidence that the angle is representative of the estimated content of the image.

12. The method of claim 11, comprising:
determining interpolation weights based on the confidence that the angle is representative of the estimated content of the image; and
interpolating the scaled pixel value based on the interpolation weights, the intermediate vertical values, and the intermediate horizontal values.

13. The method of claim 10, wherein the intermediate horizontal locations are on a line corresponding to the angle and passing through the pixel location of interest, and wherein the intermediate vertical locations are on the line.

14. The method of claim 10, wherein interpolating the intermediate horizontal values comprises interpolating an intermediate horizontal value of the intermediate horizontal values at an intermediate horizontal location of the intermediate horizontal locations based on a linear interpolation of a set of two input pixel values of the respective input pixel values, wherein the set of two input pixel values corresponds with two input pixel locations, of the input pixel locations, that are directly adjacent to and horizontally in line with the intermediate horizontal location relative to a pixel grid of the input pixel locations.

15. The method of claim 10, comprising:
interpolating:
additional intermediate horizontal values at additional intermediate horizontal locations between the input pixel locations based on the pixel location of interest and a second angle orthogonal to the angle;
additional intermediate vertical values at additional intermediate vertical locations between the input pixel locations based on the pixel location of interest and the second angle; or
the additional intermediate horizontal values and the additional intermediate vertical values; and
determining the scaled pixel value based on:
the intermediate vertical values;
the intermediate horizontal values; and
the additional intermediate horizontal values, the additional intermediate vertical values, or both.

16. The method of claim 10, comprising displaying the scaled image data on an electronic display.

17. A non-transitory, machine-readable medium comprising instructions that, when executed by one or more processors, cause the one or more processors to perform operations or to control image processing circuitry to perform the operations, wherein the operations comprise:
receiving an indicator of a selected value of a variable scaling ratio and input image data corresponding to an image, wherein the selected value of the variable scaling ratio comprises a ratio between a first resolution of the input image data and a second resolution of scaled image data;
determining a relative position of a pixel location of interest corresponding to a scaled pixel value of the scaled image data relative to input pixel locations of the input image data, wherein the input image data comprises respective input pixel values at the input pixel locations;
determining an angle corresponding to estimated content of the image at the pixel location of interest;
interpolating intermediate horizontal values at intermediate horizontal locations between the input pixel locations based on the pixel location of interest, the angle, and the respective input pixel values;
interpolating intermediate vertical values at intermediate vertical locations between the input pixel locations based on the pixel location of interest, the angle, and the respective input pixel values; and
determining the scaled pixel value based on the intermediate vertical values and the intermediate horizontal values.

18. The non-transitory, machine-readable medium of claim 17, wherein the operations comprise:
determining a first difference between a first pixel cluster and a second pixel cluster, wherein the first pixel cluster comprises an input pixel location of interest of the input pixel locations, wherein the second pixel cluster is offset from the first pixel cluster at a first potential angle;
determining a second difference between the first pixel cluster and a third pixel cluster, wherein the third pixel cluster is offset from the first pixel cluster at a second potential angle, wherein the second potential angle is different from the first potential angle; and
selecting the angle from a plurality of potential angles based on a confidence that the angle is representative of the estimated content of the image, the plurality of potential angles comprising the first potential angle and the second potential angle.

19. The non-transitory, machine-readable medium of claim 18, wherein the operations comprise:
determining interpolation weights based on the confidence that the angle is representative of the estimated content of the image; and
interpolating the scaled pixel value based on the interpolation weights, the intermediate vertical values, and the intermediate horizontal values.

20. The non-transitory, machine-readable medium of claim 17, wherein the intermediate horizontal locations are on a line corresponding to the angle and passing through the pixel location of interest, and wherein the intermediate vertical locations are on the line.
